(19) United States
(12) Patent Application Publication
(10) Pub. No.: US 2013/0266004 A1
(43) Pub. Date: Oct. 10, 2013

(54) COMMUNICATIONS SYSTEM AND A METHOD FOR COMMUNICATIONS BETWEEN INTERNET AND NGN/IMS SUBSYSTEMS

(71) Applicant: Manuel Nunez Sanz, Madrid (ES)

(72) Inventor: Manuel Nunez Sanz, Madrid (ES)

(73) Assignee: TELEFONICA, S.A., Madrid (ES)

(21) Appl. No.: 13/884,396

(22) PCT Filed: Aug. 11, 2011
(86) PCT No.: PCT/EP2011/004041

§ 371 Date: Jun. 25, 2013

(30) Foreign Application Priority Data
Nov. 19, 2010 (ES) P 201001481

(51) Int. Cl. H04L 29/06

(52) U.S. Cl. CPC H04L 29/06068
USPC 370/354

(57) ABSTRACT

The system comprises:
a IP access network connected to a NGN/IMS subsystem and being part of an Internet subsystem;
an internet user terminal (UE) connected to said IP access network to communicate with said NGN/IMS subsystem; and.
a control and media gateway (0) interconnecting said IP access network and said NGN/IMS subsystem for translating signal and media data flows from the NGN/IMS network, in a NGN/IMS protocol, to said IP access network, into a HTTP or HTTPS protocol, and vice versa.

The method comprises using the communication system provided by the invention.

### FIELD OF THE ART

The present invention generally relates, in a first aspect, to a communications system between Internet and NGN/IMS subsystems, and more particularly to a system providing means for handling HTTP and HTTPS protocols, translating them from the Internet side to the NGN/IMS side, and vice versa.

A second aspect of the invention relates to a method for communications between Internet and NGN/IMS subsystems using the system of the first aspect.

### PRIOR STATE OF THE ART

The IP Multimedia Subsystem (IMS) [2] is an architectural framework for delivering Internet Protocol (IP) multimedia services. To ease the integration with the Internet, IMS uses IETF protocols wherever possible (the terms of this collaboration are documented in RFC3113 and RFC3131). In this context, the 3GPP has adopted a number of core protocols and architectural concepts [1]: SIP (RFC3261), SDP, RTP (RFC3550), DIAMETER (RFC3588), MEGACO (H.248), COPS (RFC2748), etc.

On the other hand, the main entrance way to internet is the WWW (World Wide Web). WWW is guided by the World Wide Web Consortium (W3C) whose mission is: “To lead the World Wide Web to its full potential by developing protocols and guidelines that ensure long-term growth for the Web”. WWW works with a lot of protocols, but HTTP protocol is without question the most important among them.

Problems with Existing Solutions:

The HTTP protocol is not included in IMS architecture and therefore IMS does not provide any means to handle the HTTP protocol [3]. Therefore, this is a closed door for those millions of internet users to NGN/IMS network capabilities.

Nowadays, there are two principal types of clients:
IMS/SIP HW or SW clients: these clients (UE2 and UE3 in FIG. 1) connect to IMS subsystem through an IP connection and they send and receive control (negotiations) and media (data) information directly.
Legacy HW clients: these clients (UE4 in FIG. 1) connect to IMS subsystem through a CS network and send and receive control and media (data) information which is adapted by standard components SGW [A4] and MGW [A5] (see IMS [2]).

However, it is important to speak about another type of client (it could be called: “false client”) [UE1+A1 in FIG. 1] which is not a true client because it only sends and receives control information and it needs other external and full clients (e.g. UE2 & UE4) to complete a call. That is, these types of clients are only a controller and they set up and manage a communications relationship between two or more other parties [6]. Usually, a web interface is the way to use these “false clients”.

There are other proposals, including patent documents, which are cited in the references below, which disclose different systems representative of the state of the art of the present invention. These are:
[1] [8] “IMS AND METHOD FOR ROUTING AN HTTP MESSAGE VIA AN IMS”. The proposals of these references disclose to provide an IP Multimedia Subsystem IMS which can handle messages other than SIP. This is made up of http-proxy and http-controller which replace the CSCF functionality.
[7] “IMS SOAP GATEWAY DEPLOYMENT UTILITY”. This proposal discloses to provide a deployment utility which enables an IMS application to be accessed as a web service at an IMS SOAP gateway. This tool builds a gateway which is quite similar to A1 in FIG. 1.
[9] “SIP-HTTP APPLICATION CORRELATOR”. It discloses systems and methods providing techniques which facilitate communications between devices which utilize different protocols. Specifically, this reference describes to build a SIP interface to an http web service and in this way this web service can be included as an IMS application service.
[10] “ . . . ACCESS TO WEB SERVICES VIA DEVICE AUTHENTICATION IN AN IMS NETWORK”. The system described in this reference provides access to web services previous IMS authentication in an IMS network. It also enables the same device that has registered with the IMS network sends an HTTP message addressed to the final Web Service crossing the IMS subsystem (P-CSCF).
[11] “TECHNIQUE FOR PERFORMING SIGNALING CONVERSION BETWEEN HTTP AND SIP DOMAINS”. The International patent application corresponding to this reference relates to techniques to convert different IMS methods to HTTP messages and vice versa. No indication is done regarding the purpose or aim of these techniques.

### Description of the Invention

It is necessary to offer an alternative to the state of the art which covers the gaps found therein.

To that end, the present invention provides, in a first aspect, a communications system between Internet and NGN/IMS subsystems, comprising:

at least one IP access network connected to a NGN/IMS subsystem and being part of an Internet subsystem; and

at least one internet user terminal connected to said at least one IP access network to communicate with said NGN/IMS subsystem.

On contrary to conventional communication systems between Internet and NGN/IMS subsystems, the communication system provided by the first aspect of the invention comprises a control and media gateway interconnecting said at least one IP access network and said NGN/IMS subsystem for translating signal and media data flows from the NGN/IMS network, in a NGN/IMS protocol, to said at least one IP access network, into a HTTP or HTTPS protocol, and vice versa.

For an embodiment, the control and media gateway of the communications system of the invention comprises a WebIMS module interchanging control data and media data between said at least one IP access network and said NGN/IMS subsystem.

The control and media gateway of the communications system of the invention comprises, for an embodiment, a Web server connected to said at least one IP access network to provide said at least one internet user terminal with internet services following an http protocol.

For another embodiment, the communications system of the first aspect of the invention comprises at least a second IP access network with at least one internet user terminal connected thereto, and a second control and media gateway interconnecting a second IP access network and said NGN/IMS subsystem for translating signal and media data flows from the NGN/IMS network, in a NGN/IMS protocol, to said second IP access network, into a HTTP or HTTPS protocol, and vice versa.

Other embodiments of the system of the first aspect of the invention are described in claims 4 to 9, and also in a subsequent section.

A second aspect of the invention relates to a method for communications between Internet and NGN/IMS subsystems, which comprises using the system of the first aspect for communicating a first user, through an internet first user terminal connected to an IP access network which is connected to a NGN/IMS subsystem through said at least one control and media gateway, with a second user connected through a respective second user terminal to said NGN/IMS subsystem.

The method of the second aspect of the invention comprises, for an embodiment, carrying out said communications for a second user which second user terminal is connected to said NGN/IMS subsystem through one of:

the same control and media gateway connecting the first internet user terminal, or another control and media gateway;

an IMS client, hardware or software, of the NGN/IMS subsystem;

a roaming IMS client of another NGN/IMS network interworking with said NGN/IMS subsystem;

a Circuit-Switched legacy network interconnected with the NGN/IMS subsystem;

any user equipment which can work fine with a NGN/IMS network; and

a group formed by several user terminals connected with a multi conference service.

### BRIEF DESCRIPTION OF THE DRAWINGS

The previous and other advantages and features will be more fully understood from the following detailed description of embodiments, some of which with reference to the attached drawings (some of which have already been described in the Prior State of the Art section), which must be considered in an illustrative and non-limiting manner, in which:

FIG. 1 shows different known architectures for connecting different clients to an IMS subsystem, including the following of Third party call control (SPCC) concept;

FIG. 2 shows a new Architecture including the communication system of the first aspect of the invention;

FIG. 3 shows schematically the connection and interaction of the control and media Gateway of the system of the first aspect of the invention, with user and network planes, for an embodiment;

FIG. 4 schematically depicts the inner modules of the control and media Gateway of the system of the first aspect of the invention, also designated as access node element, for an embodiment;

FIGS. 5 to 9 show different embodiments representing general procedures carried out according to the method of the second aspect of the invention.

FIG. 10 shows a data flow of a registration process of an embodiment of the method of the second aspect of the invention:

FIG. 11 shows another embodiment of the method of the second aspect of the invention, regarding a session flow where a web user initiates and terminates a call.

FIG. 12 shows a data flow similar to that of FIG. 10, but for an embodiment regarding a deregistration process.

### DETAILED DESCRIPTION OF SEVERAL EMBODIMENTS

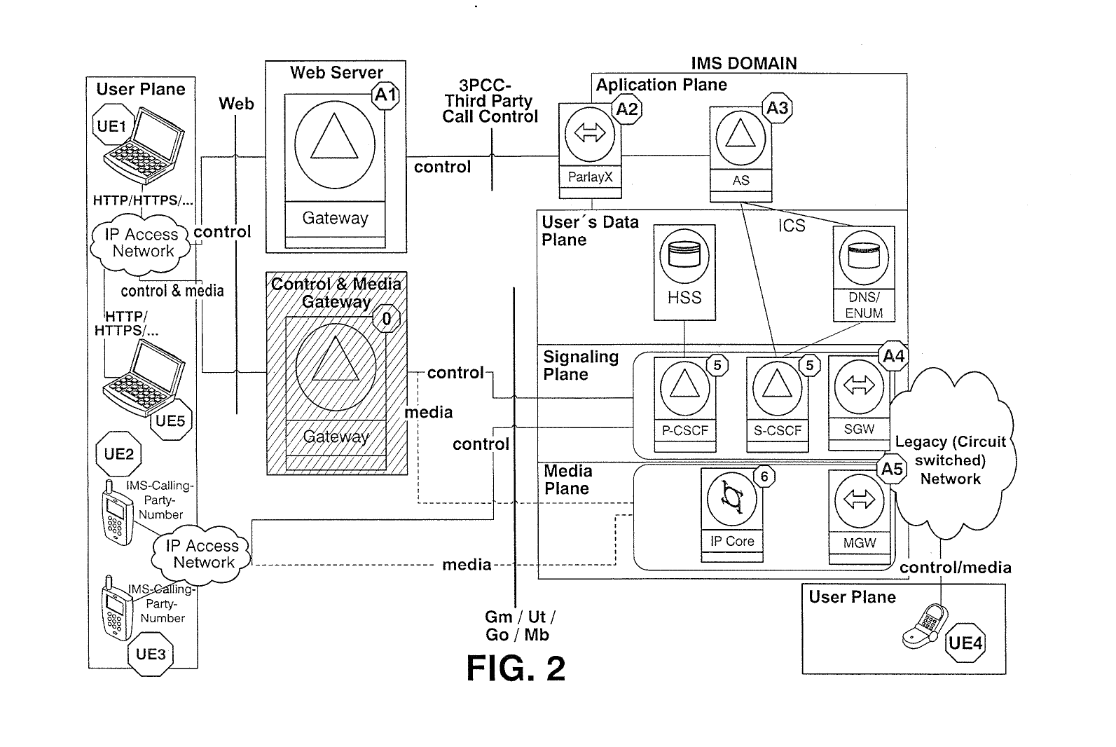

The present invention relates traditional internet users to an IMS network through an interpreter, the control and media gateway indicated by the referral 0 in FIG. 2, which is comprised by the communication system of the first aspect of the present invention. This gateway 0 will act on behalf of users connected thereto (UE1 and UE5 in FIG. 2), like an IMS client for the network. In this client role, it will translate signal and media flows from IMS networks to internet and vice versa. That is, it will act like a gateway between both worlds.

As FIG. 2 shows this new “control & media gateway” 0 has two standard and main interfaces:

In IMS side it acts like a client in front of IMS network (Gm reference point) (see reference [4], Section 2.3).

In Web side it acts like a web server in front of final web user and it interchanges control and media dates with the final client (probably a browser).

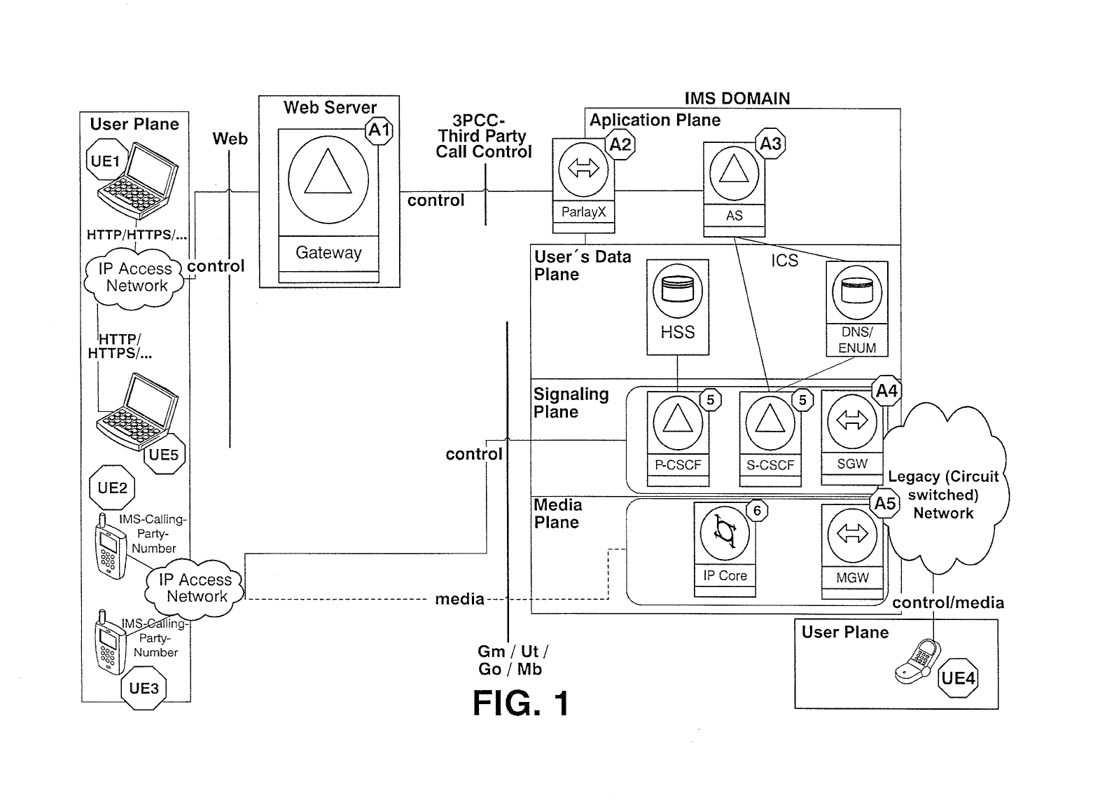

Conventional elements shown in FIG. 2, i.e. those also shown in FIG. 1, mainly those referred to the IMS domain, are described in the below cited references, particularly in [4]. The person skilled in the art should go to those references to obtain said description of said conventional elements.

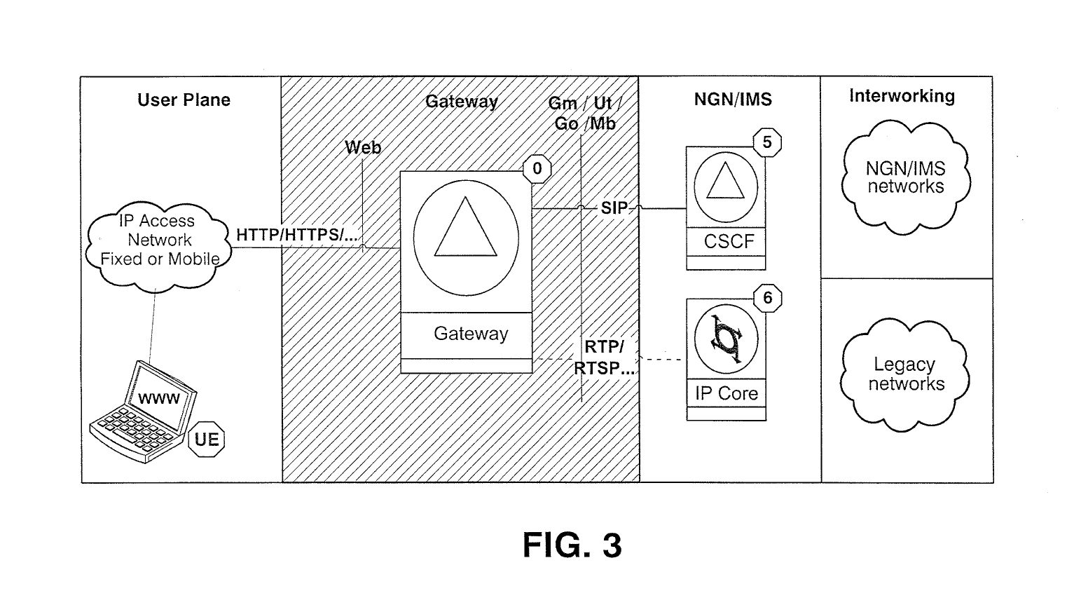

FIG. 3 shows the control and media gateway 0 and his interworking with User and NGN/IMS network.

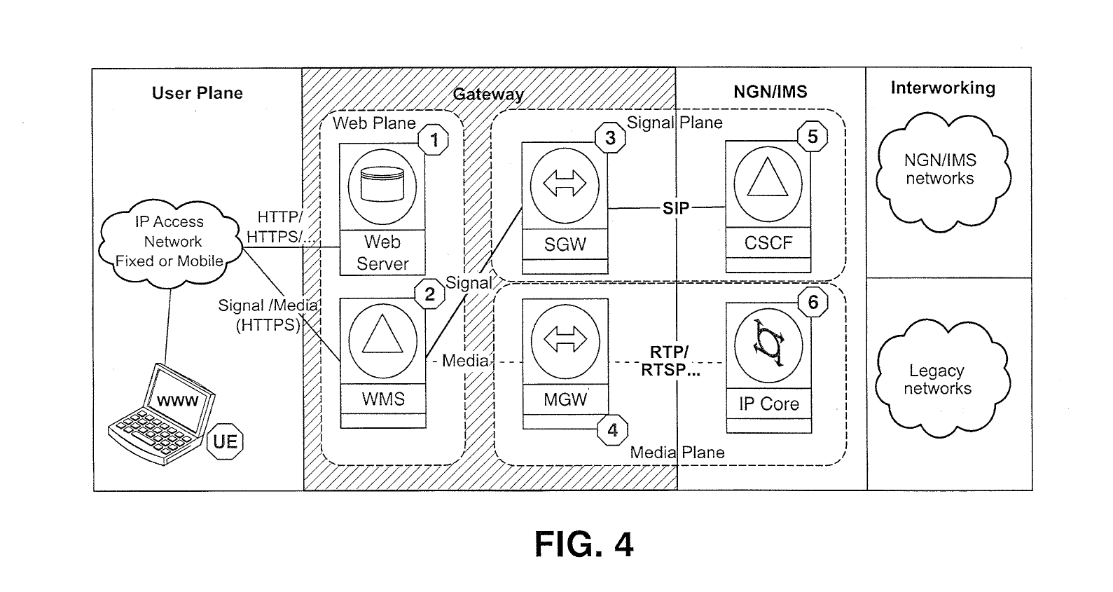

There are multiples alternatives to implement this gateway 0, one of them is show in FIG. 4 with its principal functionalities. In any case, these functionalities and interfaces could be included in just one standalone process or in different processes with different hardware, or any mixture of these options, depending on the embodiment. But it is important to keep the IMS ([4]. Section 2.3) and Web [5] standard interfaces, being the Gm reference point between User Endpoint (UE) and a P-CSCF the most important of them in IMS side.

FIG. 4 illustrates an embodiment of the control and media gateway 0 of the invention, also named herein as access node element, as one example way of an implementation case. Other implementations, not illustrated, are also possible. The concept or functionality is not changed to implement in other ways.

As per FIG. 4, the control and media gateway 0 of the invention comprises:

1. A Web Server module 1: This module is just a traditional web server [1] [12] which serves the main page to access to service.

2. A WebIMS module, or WIMS 2: This is the main module, according to functionality criteria. In its user side it interchanges signal data (user, password, phone numbers . . . ) and media data (voice, video, etc.). One possible method to carry these data is over RTMPS/HTTPS [13], but any other mechanisms which carry data encapsulated over HTTP are possible. These real time data are encoded with a codec (H.264, G.711, Nelly Moser Asao . . . [14]) to optimize the channel.

3. Signal GateWay module, or SGW 3: This module implements the communication towards IMS network side. It requests or answers every SIP procedure [2] in name of user (register, invite . . . ). This module must implement every procedure and protocol of an IMS client interface: Gm, Ut [16].

4. Media GateWay, or MGW module 4: This module implements the media bidirectional conversion between data in user plane and network plane. This conversion could be only a transport conversion HTTPS⇄RTP, or also a transcoding conversion if a recodification [15] is needed. This module must implement the RTP or RTPS protocols to interchange data media with its remote peer.

Depending on the embodiment, modules 3 and 4 are independent modules with proprietary channel with module 2, or part of it. In any case the idea (functionality and interface) is the same.

### General Procedures

There are several general procedures which define flows of signal and media data for different embodiments of the method of the second aspect of the invention. The following cases are every one of them:
1. The http user (UE1) initiates the call toward an IMS user (UE2). There are another two options to finish this context:
   1. The http user (UE1) also ends the call.
   2. The IMS user (UE2) ends the call.
2. The http user (UE1) initiates the call toward other http user (UE5). There are another two options to finish this context:
   1. The http user (UE1) also ends the call.
   2. The http user (UE5) ends the call.
3. The http user (UE1) initiates the call toward a CS user (UE4). There are another two options to finish this context:
   1. The http user (UE1) also ends the call.
   2. The CS user (UE4) ends the call.
4. One CS user (UE4) initiates the call toward the http user (UE1). There are another two options to finish this context:
   1. The http user (UE1) also ends the call.
   2. The CS user (UE4) ends the call.
5. One IMS user (UE2) initiates the call toward the http user (UE1). There are another two options to finish this context:
   1. The http user (UE1) also ends the call.
   2. The IMS user (UE4) ends the call.

In every case, signal and media conversions are according to the above description regarding FIG. 4.

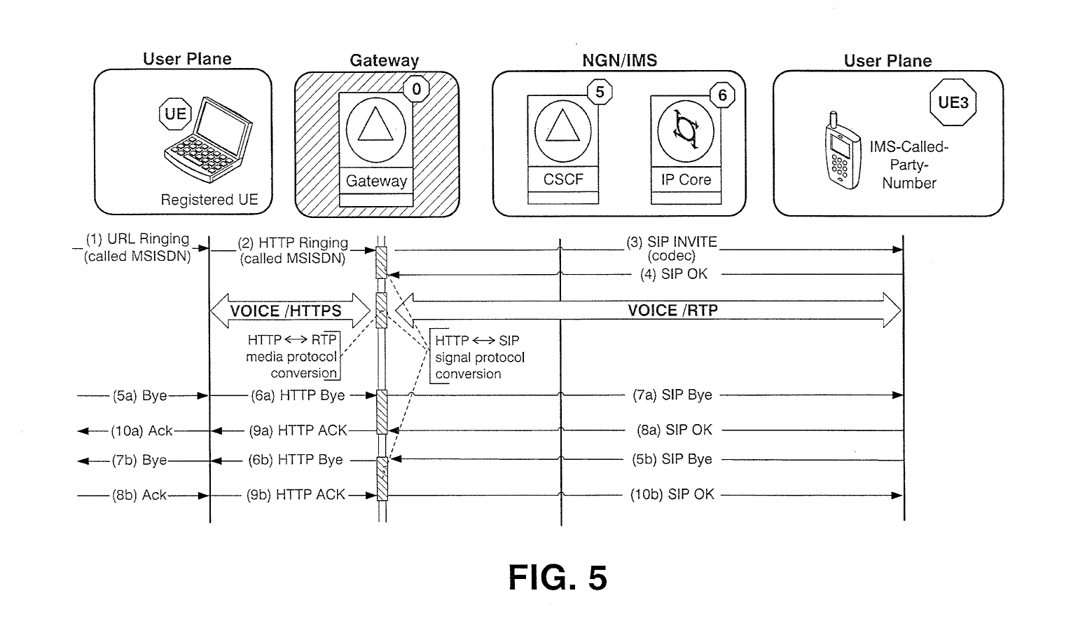

FIG. 5 shows the above indicated options 1.1 and 1.2, one of the most general procedures where the control and media gateway 0 converts the call initiated by the http user (UE1) towards another user in IMS plane (UE4). In this case there are two sub-options according the user who ends the call:
Option a (5a to 7a) shows as the http user ends the call (1.1).
Option b (5b to 7b) where the IMS user ends the call (1.2).

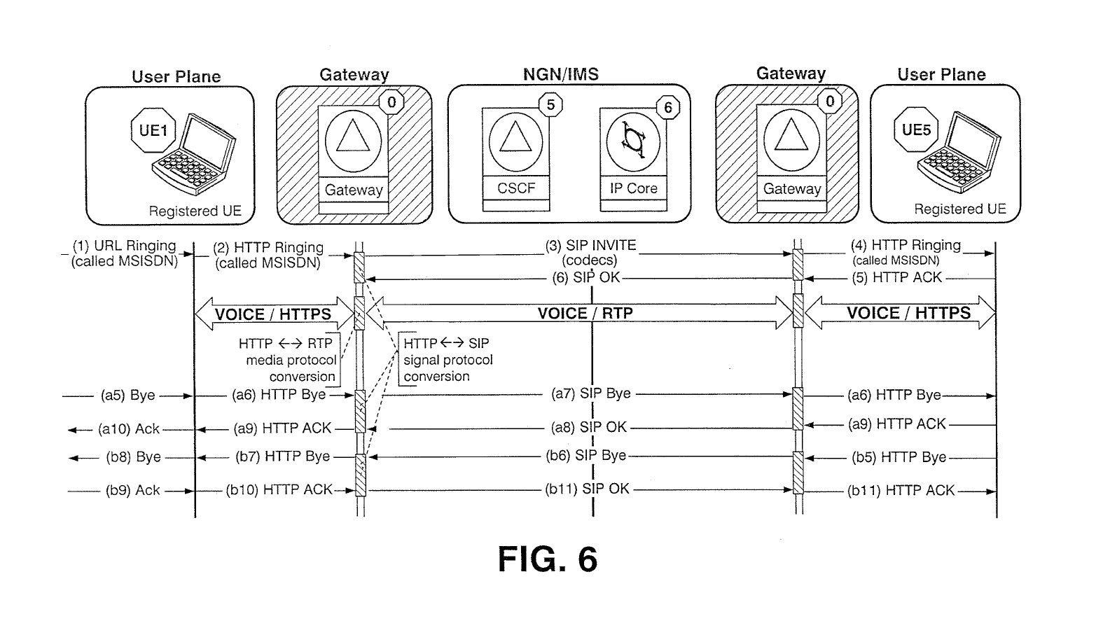

FIG. 6 shows options 2.1 and 2.2 indicated above, where the control and media gateway 0 converts the call initiated by the http user (UE1) towards another user in http plane (UE5). In this case there are two sub-options according the user who ends the call:

Option a (a5 to a10) shows as the UE1 ends the call (2.1).

Option b (b5 to b11) where the UE5 ends the call (2.2).

In FIG. 6, the two illustrated control and media gateways 0 could be exactly the same instance or another instance, for performance reasons.

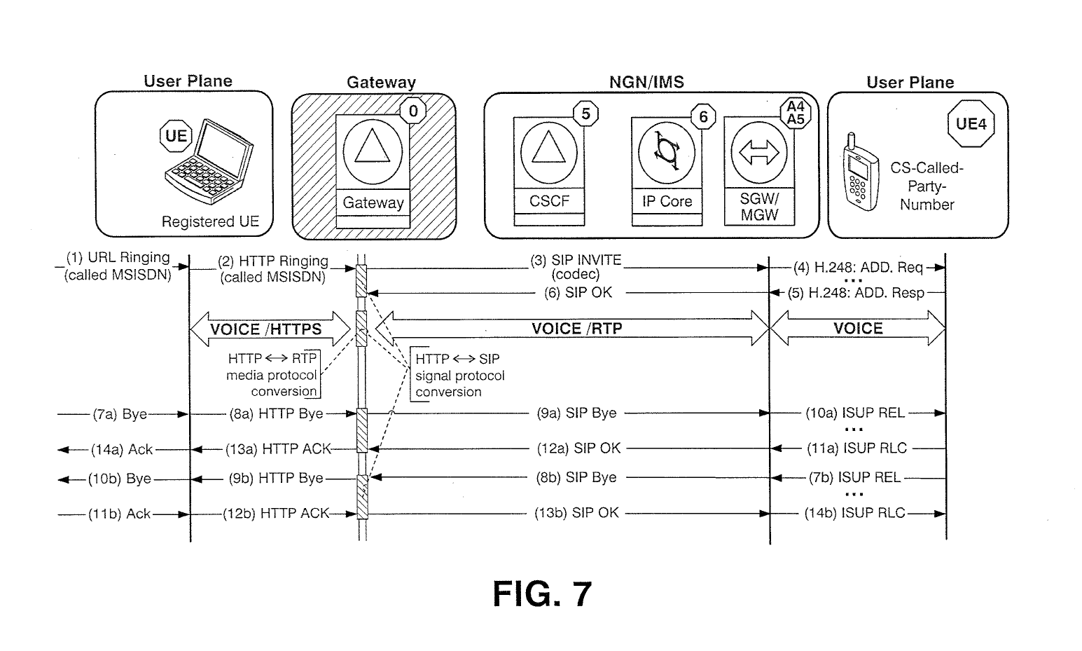

FIG. 7 shows options 3.1 and 3.2 indicated above, where the control and media gateway 0 converts the call initiated by the http user (UE1) towards another user in CS plane (UE4). In this case there are two sub-options according the user who ends the call:

Option a (7a to 14a) shows as the http user ends the call (3.1).

Option b (7b to 14b) where the CS user ends the call (3.2)

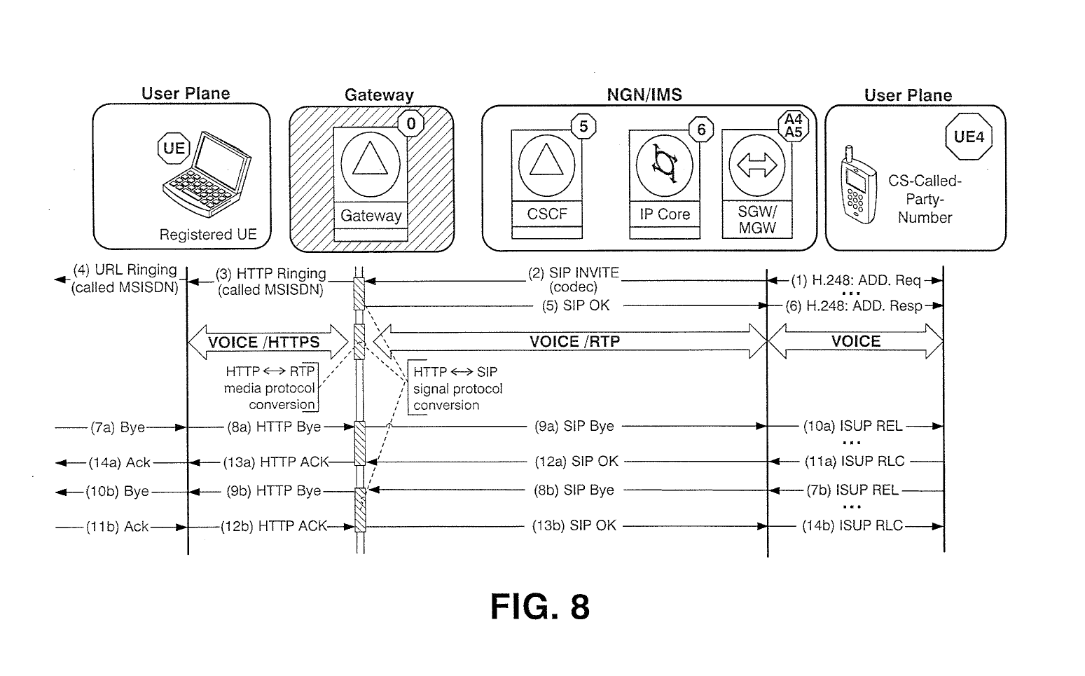

FIG. 8 shows options 4.1 and 4.2 described above, which represent one of the most general procedures where the control and media gateway 0 converts the call initiated by the CS user (UE1) towards another user in IMS plane (UE4). In this case there are two sub-options according the user who ends the call:

Option a (7a to 14a) shows as the http user ends the call (4.1).

Option b (7b to 14b) where the IMS user ends the call (4.2).

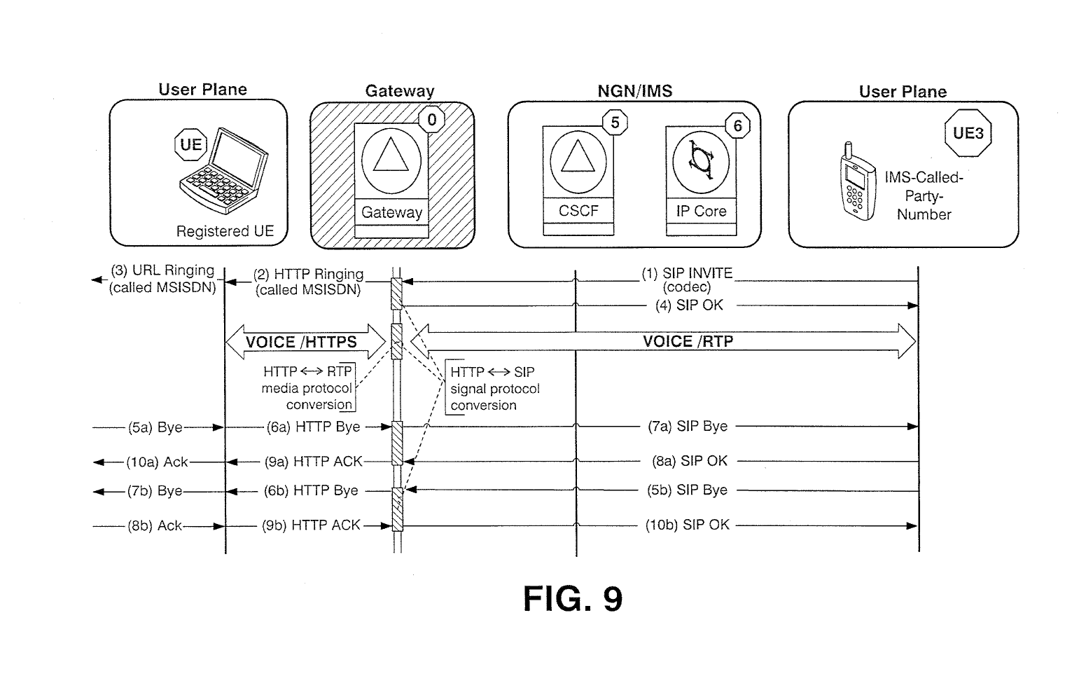

FIG. 9 shows options 5.1 and 5.2 indicated above, where the gateway converts the call initiated by the IMS user (UE3) towards another user in http plane (UE1). In this case there are two sub-options according the user who ends the call:

Option a (5a to 10a) shows as the http user ends the call (5.1).

Option b (5b to 10b) where the IMS user ends the call (5.2).

### Register Process

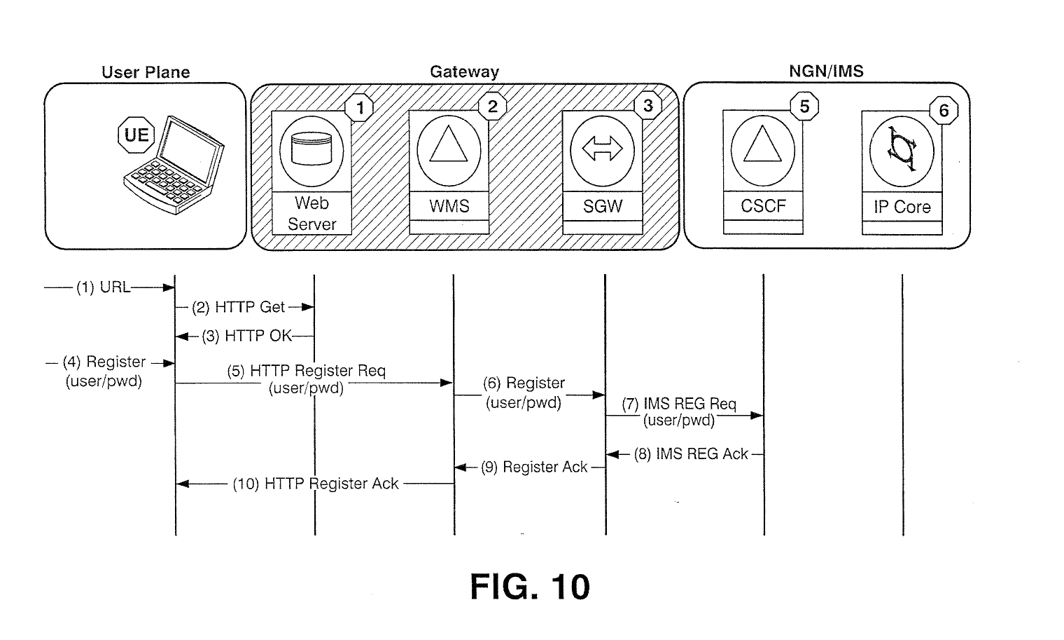

FIG. 10 shows a register process of a user, according to an embodiment of the method of the second aspect of the invention. Some steps could change depending on the implementation options, but the main steps are the next, carried out sequentially:
1. Web user invokes the URL in his/her browser.
2. Web Server 1 gets that request.
3. Web Server 1 responds with the home page.

4. User introduces his user and password in an http page, or https in case network operator wants to provide a secure channel, as identifying information, indicating the desire of registering
5. WIMS 2 receives that identifying information.
6. WIMS 2 sends this information to SGW 3 module.
7. SGW 3 translates this information to NGN/IMS signalling and sends it to IMS core of the network 5.
8, 9, and 10. The ACK is coming back from the IMS network, in the form of corresponding acknowledge signals in sequence from the NGN/IMS subsystem to the internet first user terminal.

### Detail Session Process

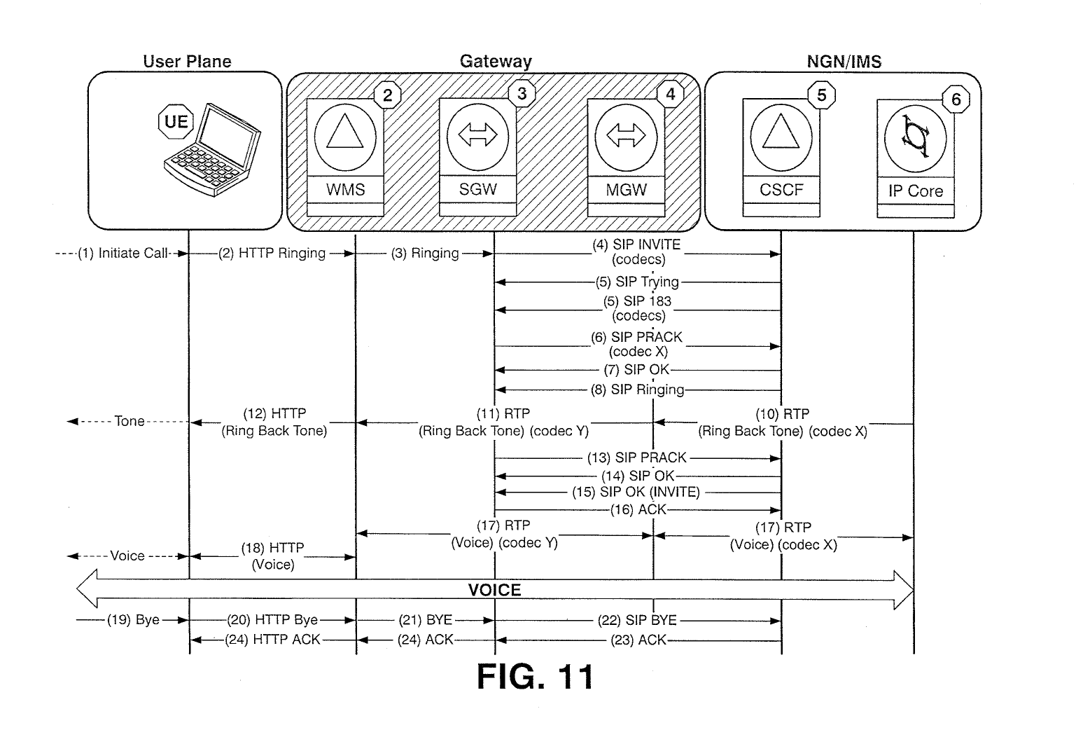

This is the more complex scenario with more options and variation owing to the fact that the order and direction the flow depending of who user initiates the call, used codecs, etc. FIG. 11 shows an embodiment of the method of the second aspect of the invention regarding said session process where the web user initiates the call.

Web user initiates the call clicking, for example, an icon in the web page.

2 to 3. SWG 3 receives the call request with destination information.

4 to 8. IMS negotiation phase between SWG 3 and CSCF 5 to establish the call between calling user (web user) and called user (IMS user or even legacy user). In this phase the selected codec is negotiated.

10 to 12. Ring back Tone from IMS network 5 to calling user, where MWG 4 transcodes the media.

13 to 16. Call session establishment between SWG 3 and CSCF 5.

17. Bbidirectionally transmitting encoded voice between the IMS network 5 and the WIMS 2, where the MWG 4 transcodes the media data encoding said voice.

18. Translating and enclosing, the WebIMS module, the encoded voice received from the Media Gateway module, into a packet according to HTTP or HTTPS protocol, and vice versa, to establish a bidirectional voice communication.

19 to 24. Call session termination process requested by web user.

In this last example, web user initiates and terminates the calls, but there are other cases as following:
Web user initiates the call (calling user) but the other side (called user) terminates it.
Web user is called (called user) by the other side (calling user). In this case any of them could terminate the call.

### Deregister Process

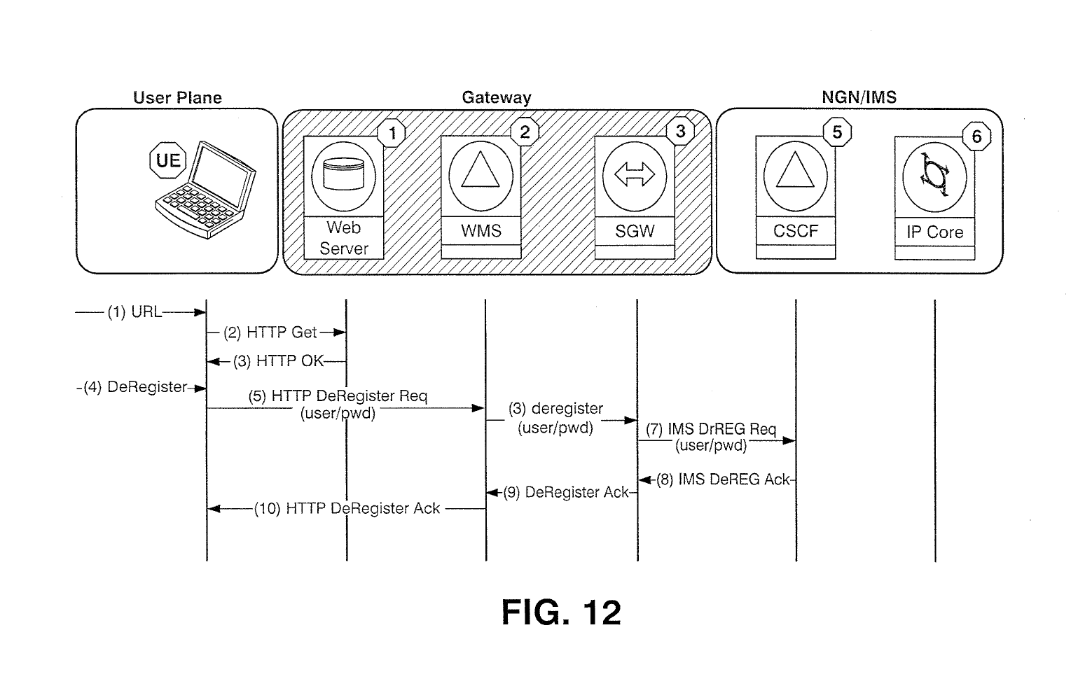

FIG. 12 shows the deregister process of a user as per an embodiment of the method provided by the second aspect of the invention. Some steps could change depending on the implementation options, but the general idea is:
1. Web user invokes the URL in his/her browser.
2. Web Server 1 gets that request.
3. Web Server 1 responds with the home page.
4. User introduces his user and password in an http page, or https in case network operator wants to provide a secure channel, as identifying information, indicating the desire of deregistering
5. WIMS 2 receives that information.
6. WIMS 2 sends this information to SGW 3 module.
7. SGW 3 translates this information to IMS signalling and sends it to IMS core of the network 5.
8, 9, and 10. The ACK is coming back from the IMS network.

### Other Remarks

For every embodiment, the main feature of the invention is the control and media gateway 0, which offers a client interface towards NGN/IMS network and a web server interface towards http user plane client.

In other hand, herein the flow for a voice session has been explained, but it is only an application example, because the general concept is obviously extending to other kind of application, such those including multimedia sessions, messages, and any other IMS services.

### Advantages of the Invention

There are several advantages with this invention:
From a user's point of view:
   Every application or service in IMS environment is reached across a web page. It is easier and more intuitive for general public.
   Users can use transparently the video or phone functionalities of the IMS networks. Or even the legacy Circuit-Switched using the native IMS-CS conversions.
   Users do not need any extra HW or SW to complete calls, only a web page is enough.
   If this functionality runs over any generic HW or SW with a browser, users can use their PCs (windows, linux, mac), mobile device, game platforms . . .
From an operator's point of view:
   Open a new gateway to its NGN/IMS network
   The www networks is coming to any daily device, therefore this systems will be a new converging line.
   Without installed HW of SW in every UE the maintenance costs decrease significantly.
   Every new modification or improvement is made immediately because users do not need to install them.
   Every service (old or new) for IMS users automatically work for these web users.

A person skilled in the art could introduce changes and modifications in the embodiments described without departing from the scope of the invention as it is defined in the attached claims.

### ACRONYMS AND ABBREVIATIONS

3GPP 3rd Generation Partnership Project

CS Circuit-Switched

COPS Common Open Policy Service

ENUM Universal Mobile Telecommunication System

HTTP HyperText Transfer Protocol

HW Hardware

IETF Internet Engineering Task Force

IMPU IP Multimedia Public Identity

IMS IP Multimedia Subsystem

MEGACO MEdia GAteway COntrol

NAT Network Address Translation

PLMN Public Land Mobile Network

POTS Plain Old Telephone Service

PSTN Public Switched Telephone Network

RTP Real-time Protocol

SDP Session Description Protocol

SIP Session Initiation Protocol

SW Software

TISPAN Telecommunications and Internet converged Services and Protocols for Advanced Networking

UE User Equipment

URI Uniform Resource Identifier

W3C World Wide Web Consortium

### REFERENCES

[1] White Paper: “Introduction to IMS. Standards, protocols, architecture and functions of the IP Multimedia Subsystem”. Motorola, Inc. http://www.acalmicrosystems.co.uk/whitepapers/ims1.pdf

[2] Book: “The 3G IP multimedia subsystem (IMS)”. ISBN-10: 0470871563.

[3] Thesis: “A System Architecture for SIP/IMS-based Fixed/Mobile Multimedia Services on Thin Clients”. Xianghan Zheng and Fang Chen. Adger University College.

[4] Book “The IMS IP Multimedia Concepts and Services in the Mobile Domain” ISBN 0-470-87113-X.

[5] http://www.w3.org/

[6] Third Party Call Control (3PCC). RFC3725. http://www.rfc-editor.org/rfc/rfc3725.txt

[7] US 2007/0055678A1 “IMS SOAP GATEWAY DEPLOYMENT UTILITY”.

[8] WO 2008141660A1 “IP MULTIMEDIA SUBSYSTEM (IMS) AND METHOD FOR ROUTING AN HTTP MESSAGE VIA AN IMS”.

[9] WO 2009/109901 A1 “SIP-HTTP APPLICATION CORRELATOR”.

[10] US 20080177889A1 “SYSTEMS, METHODS AND COMPUTER PROGRAM PRODUCTS FOR PROVIDING ACCESS TO WEB SERVICES VIA DEVICE AUTHENTICATION IN AN IMS NETWORK”

[11] WO 2009/106117A1 “TECHNIQUE FOR PERFORMING SIGNALING CONVERSION BETWEEN HTTP AND SIP DOMAINS”

[12] Web Server. http://en.wikipedia.org/wiki/Web_server

[13] RTMPS. http://en.wikipedia.org/wiki/Real_Time_Messaging_Protocol

[14] Audio and Video Codecs http://es.wikipedia.org/wiki/C%C3%B3dec

[15] Transcoding http://en.wikipedia.org/wiki/Transcode

[16] IMS: http://en.wikipedia.org/wiki/IP_Multimedia_Subsystem

1-15. (canceled)

16. A communications system between Internet and NGN/IMS subsystems, comprising:
at least one IP access network connected to a NGN/IMS subsystem and being part of an Internet subsystem;
at least one internet user terminal (UE) connected to said at least one IP access network to communicate with said NGN/IMS subsystem,
a control gateway interconnecting said at least one IP access network and said NGN/IMS subsystem performing signalling conversion that permits said (UE) to initiate media sessions towards said NGN/IMS subsystem,
where said control gateway is a control and media gateway (0) further translating signal and media data flows from the NGN/IMS network, in a NGN/IMS protocol, to said at least one IP access network, into a HTTP or HTTPS protocol, and vice versa and wherein said control and media gateway (0) further comprises a Media GateWay module (4) providing media data interchanging by implementing RTP or RTPS protocols to carry out a transport conversion from HTTPS to RTP, and vice versa by interconnecting a WebIMS module (2) with said NGN/IMS network.

17. A communications system as per claim 16, wherein said control and media gateway (0) comprises a WebIMS module (2) interchanging control data and media data between said at least one IP access network and said NGN/IMS subsystem.

18. A communications system as per claim 17, wherein said control and media gateway comprises a Web server (1) connected to said at least one IP access network to provide said at least one internet user terminal (UE) with internet services following an http protocol.

19. A communications system as per claim 17, wherein said control and media gateway (0) further comprises a Signal GateWay module (3) interconnecting said WebIMS module (2) with said NGN/IMS network for control data interchanging.

20. A communications system as per claim 19, wherein said Signal GateWay module (3) implements procedures and protocols of an NGN/IMS client interface, including SIP procedures.

21. A communications system as per claim 20, wherein said Signal Gateway module (3) is connected to said NGN/IMS network through a Call Session Control Function, CSCF (5), following communications based on SIP commands.

22. A communications system as per claim 16, wherein said Media GateWay module (4) is intended for further carrying out a transcoding conversion if a recodification is needed.

23. A communications system as per claim 22, wherein said Media Gateway module (4) is connected to said NGN/IMS network through an IP Core (6).

24. A communications system as per claim 16, comprising at least a second IP access network with at least one internet user terminal connected thereto, and a second control and media gateway interconnecting a second IP access network and said NGN/IMS subsystem for translating signal and media data flows from the NGN/IMS network, in a NGN/IMS protocol, to said second IP access network, into a HTTP or HTTPS protocol, and vice versa.

25. A method for communications between Internet and NGN/IMS subsystems, comprising communicating a first user through an internet first user terminal connected to an IP access network which is connected to a NGN/IMS subsystem through at least one control gateway, with a second user connected through a respective second user terminal to said NGN/IMS subsystem, the method using the system as per 16, comprising translating signal and media data flows, at least one control and media gateway, from the NGN/IMS network, in a NGN/IMS protocol, to said at least one IP access network, into a HTTP or HTTPS protocol, and vice versa, and interchanging media data, a Media GateWay module of said control and media gateway for media data interchanging by implementing RTP or RTPS protocols to carry out a transport conversion from HTTPS to RTP, and vice versa.

26. A method as per claim 25, comprising a register process for said first user comprising carrying out the next steps sequentially:
requesting said first user a desired URL in a browser displayed on his internet user terminal;
receiving said Web server that requested URL and delivering the corresponding home page to said internet first user terminal;
introducing, said first user, his user name and password in an HTTP or HTTPS page, accessed through said home page, as identifying information, indicating the desire of registering;
receiving said WebIMS module said identifying information and sending the latter to said Signal GateWay module;
translating, said Signal GateWay module, said identifying information to NGN/IMS signalling and sending it to NGN/IMS subsystem; and
sending corresponding acknowledge signals in sequence from the NGN/IMS subsystem to the internet first user terminal.

27. The method as per claim 26, comprising a deregister process for said first user comprising carrying out the same steps carried out for said register process, with the difference that the first user indicates the desire of deregistering instead of registering.

28. A method as per claim 26, comprising, after said first user has been registered according to said register process, carrying out a session process for said first user comprising carrying out the next steps sequentially:
requesting to initiate a call, the first user, by interacting, at his internet first user terminal, with said home page or a web page linked thereto;
receiving, said Signal GateWay module said call request with destination information, through said WebIMS module;
IMS negotiating said Signal Gateway module and said CSCF to establish the call between said first user, or calling user, and said second user, or called user, said IMS negotiation including at least the selection of a codec;
sending corresponding Ring back Tone signals in sequence from the NGN/IMS subsystem to the internet first user terminal, where said Media GateWay transcodes the media data;
establishing the requested call session establishment between the Signal GateWay and the CSCF;
bidirectionally transmitting encoded voice between the IMS subsystem and the WebIMS module, where the Media Gateway module transcodes the media data encoding said voice.
translating, the WebIMS module, the encoded voice received from the Media Gateway module, into a packet according to HTTP or HTTPS protocol, and vice versa, to establish a bidirectional voice communication;
terminating the session process by the first or the second user.

29. The method as per claim 25, comprising carrying out said communications for a second user which second user terminal is connected to said NGN/IMS subsystem through one of:
the same control and media gateway connecting the first internet user terminal, or another control and media gateway;
an IMS client, hardware or software, of the NGN/IMS subsystem;
a roaming IMS client of another NGN/IMS network interworking with said NGN/IMS subsystem;
a Circuit-Switched legacy network interconnected with the NGN/IMS subsystem;
any user equipment which can work fine with a NGN/IMS network; and
a group formed by several user terminals connected with a multi conference service.
